(19) United States
(12) Patent Application Publication
(10) Pub. No.: US 2008/0043007 A1
(43) Pub. Date: Feb. 21, 2008

(54) Active Matrix Array Device and Method for Driving Such Device

(75) Inventor: Kenneth R. Whight, Horsham (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,736

(22) PCT Filed: Sep. 8, 2005
(86) PCT No.: PCT/IB05/52928

§ 371 Date: Mar. 6, 2007

(30) Foreign Application Priority Data
Sep. 9, 2004 (GB) 0420011.9

(51) Int. Cl. G06F 3/038; G09G 3/20

(52) U.S. Cl. 345/211; 345/55

(57) ABSTRACT

An active matrix array device (100) comprises a plurality of matrix elements (110a-i), each matrix element comprising a charge storage device (112a-i), and a plurality of charging conductors (142, 144, 146; 704). Each charging conductor is coupled to a subset of the plurality of matrix elements (110a-i) via respective thin film transistors (116a-i). A driver circuit (120; 702) generates a plurality of output voltages, and a plurality of voltage modification circuits (706, 806) are used to apply a step voltage waveform for modifying the output voltage to modify a charge time of one of the charge storage devices (112a-i) coupled to the charging conductor (142, 144, 146; 704).

The invention relates to an active matrix array device comprising a plurality of matrix array elements, each having a charge storage device.

The invention also relates to an electronic display device having such an active matrix array device.

The invention further relates to a method for driving the active matrix array device.

Active matrix array devices are being used in many different areas ranging from sensor type applications to display type applications. In the larger display field, active matrix array devices are increasingly competing with the more traditional cathode ray tube displays as the leading technology.

Typically, matrix array devices have crossing sets of addressing conductors and charging conductors, and have matrix array elements coupled to a respective conductor from each set at the crossing intersections. In the case of matrix array display devices, the charging conductors are typically known as the column conductors of the active matrix array device and are arranged to drive a set of values to a row of matrix array elements under control of a column driver circuit, whereas the addressing conductors are typically known as the row conductors of the active matrix array device and are sequentially activated by a further driver circuit like a row driver circuit to select the row of matrix array elements to be addressed. In display devices of this kind, the frequencies of charging and addressing the various rows of active matrix array elements are usually governed by a characteristic of the video signal, like its field frequency, with the timing signals that operate the row and driver circuits being extracted from the video signal by dedicated hardware.

However, the use of such active matrix array devices is not without problems, especially when thin film transistors (TFTs) are being used to enable the programming of the matrix array elements, such as liquid crystal display (LCD) or organic light emitting diode (o-LED) pixels via the conductors coupled to the TFTs. TFTs have relatively poor conductivity in comparison to a monolithic transistor, due to the poorer electron mobility in a TFT. Also, when charging a charge storage element like a capacitor and/or a pixel in a matrix array element for instance for storing a brightness level of the pixel, the conductivity of the TFT decreases with increasing charge stored in the charge storage element, because its source drain voltage drops, which has a detrimental effect on the TFT electron mobility. Consequently, the time required to charge an active matrix array element to its predefined charge value can exceed the available charge time, in which case the amount of charge stored in the matrix element charge storage element is insufficient. In display devices, this leads to faulty brightness levels, which is a highly unwanted phenomenon. The TFT electron mobility can be improved by changing the dimensions of the TFT like increasing the channel width, but leads to a loss of aperture, which is an unwanted side-effect.

A solution to this problem has been provided in US patent application US 2001/0040548 A1, which discloses a driver circuit arrangement for an active matrix LCD device. The driver circuit arrangement includes a ramp-voltage generator coupled to the respective inputs of a plurality of sample and hold circuits, with the ramp-voltage generator generating a voltage waveform at a maximum voltage value in the beginning of the charge cycle of the corresponding LCD pixel. The maximum voltage is maintained for a part of the charge cycle, after which the output voltage is gradually reduced. The digital brightness information of the corresponding pixels is transformed into a pulse width by several latch circuits. The width of the pulse controls how long the corresponding sample and hold circuit samples the voltage waveform from the ramp-voltage generator. Consequently, the addressed pixels of the active matrix array are exposed to a maximum voltage for a substantial part of their charge cycle, thus reducing the time it takes to charge the pixels.

However, this arrangement has several drawbacks. First of all, it is a complex architecture needing a substantial amount of hardware in the driver circuit, which adds to the cost of the active matrix array device. In addition, it is restricted to ramp-voltage based drive signal generation, which means that other driver circuit architectures, like voltage-divider type driver circuits that produce a limited number of discrete brightness outputs, cannot benefit from this arrangement. Furthermore, it is not trivial to avoid overcharging of pixels with this arrangement, especially when the pixel needs to be programmed to a relatively low brightness level.

According to the invention, there is provided an active matrix array device comprising:

a plurality of matrix elements, each matrix element comprising a charge storage device;

a plurality of charging conductors, each charging conductor being coupled to a subset of the plurality of matrix elements via respective thin film transistors; and

a driver circuit for generating a plurality of output voltages and comprising a plurality of voltage modification circuits, each driver circuit output being coupled to one of the charging conductors via one of the voltage modification circuits, each voltage modification circuit being arranged to apply a step voltage waveform for modifying the output voltage to modify a charge time of one of the charge storage devices coupled to the charging conductor.

By coupling a voltage modification circuit to each output of the driver circuit, the driver circuit can be any known driver circuit, because the modification of the output voltages is unrelated to the actual generation of the output voltages. Thus, the arrangement of the present invention is much more flexible than for instance the arrangement disclosed in US patent application US 2001/0040548 A1. The stage output is modulated by a voltage waveform of a predefined shape, which may be based on simulations of the conductive behaviour of the TFTs used to couple the matrix array elements to their charging conductors. Thus, an overdriving voltage, that is, a voltage larger than the intended voltage to be stored in the charge storage device of the matrix array element, may be applied to the active matrix array element in a first part of a charge cycle of its charge storage element to reduce the charge time of the charge storage element. This is particularly advantageous in high-definition TV applications, where the active matrix array element address time, that is, the allowed time to store a charge in its charge storage device corresponding to a required brightness level, is reduced with respect to normal definition TVs using 50 or 60 Hz refresh rates. It is also advantageous in situations where the active matrix array of a size that, because of the length of the conductors, the impedance of the charging conductors can become a significant influence of the charging times of the matrix array elements. By applying an overdriving voltage to the matrix array element during a part of its charge cycle, this effect is countered and a shorter charge time is obtained to charge the charge storage device of the active matrix array element.

The use of a step voltage to modify the drive voltage enables low cost implementation of the modification scheme.

The step voltage waveform may have a step height which is a constant proportion of the output voltage of the stage. In this way, the overvoltage drive depends on the desired drive level itself. Other schemes are possible, for example a discrete number of possible voltage step heights, rather than a constant proportion multiplication.

The step voltage waveform can be applied for a time that depends on the initial voltage state of the matrix element being driven. This initial voltage state determines the required change in voltage, and therefore influences the level of overvoltage drive that will be appropriate. For this purpose, a frame store may be provided for storing the voltage applied to each matrix element during a preceding addressing phase.

The use of a frame store should preferably be avoided, as this introduces additional expense if no frame store is required for other purposes. There are applications in which a frame store is already used, in which case the invention can benefit from the use of that frame store.

As an alternative, current sensing circuitry can be provided for measuring a charging current during initial application of an output voltage to a charging conductor. Thus, the step voltage can be applied initially, and the charging characteristics determined. These charging characteristics will depend on the initial voltage of the matrix element driven, and the step voltage waveform can thus be applied for a time that depends on the measured current.

In another embodiment, the step voltage is applied for a time that depends on the most recent previous output voltage applied to the charging conductor. In this case, a memory may be provided for storing the most recent previous output voltages applied to the charging conductors.

Whether the previous voltage applied to the matrix element is more important or the previous voltage applied to the charging conductor (but for a different matrix element) will depend on the different capacitances and voltage variations in the device. One of the two effects may be dominant, or else a voltage overdrive scheme can combine the two approaches.

The active matrix array device may comprise a display device, and the matrix elements then comprise display pixels, for example liquid crystal display pixels or organic light emitting diode display pixels.

The invention also provides a method of addressing an active matrix array device, the device comprising a plurality of matrix elements, each matrix element comprising a charge storage device, and a plurality of charging conductors each coupled to a subset of the plurality of matrix elements via respective thin film transistors, the method comprising:

providing a matrix element drive signal;

modifying the drive signal by adding a step voltage waveform to the matrix element drive signal for reducing the charging time for the charge storage device to be charged to the drive signal.

Again, the step of the step voltage waveform can be applied for a time that depends on the initial voltage of the matrix element being driven, and this can be determined by measuring a charging current during initial application of the modified voltage to a charging conductor.

Again, the step can be applied for a time that depends on the most recent previous drive voltage applied to the charging conductor.

The voltage waveform generator can be programmable. In this way, the function that is implemented in the voltage waveform generator may be determined after the active matrix array device is produced, in which case the function may be based upon the differences between intended and actual brightness levels in case of an active matrix array device being used as a display device. This allows compensating for variations in the production process. It is even feasible that such measurements are used to compensate for active matrix array performance degradation during its lifetime, for instance compensation for the ageing effects on the various components of LCD or o-LED based active matrix arrays like the TFTs or the o-LED materials.

The invention is described in more detail and by way of non-limiting examples with reference to the accompanying drawings, wherein:

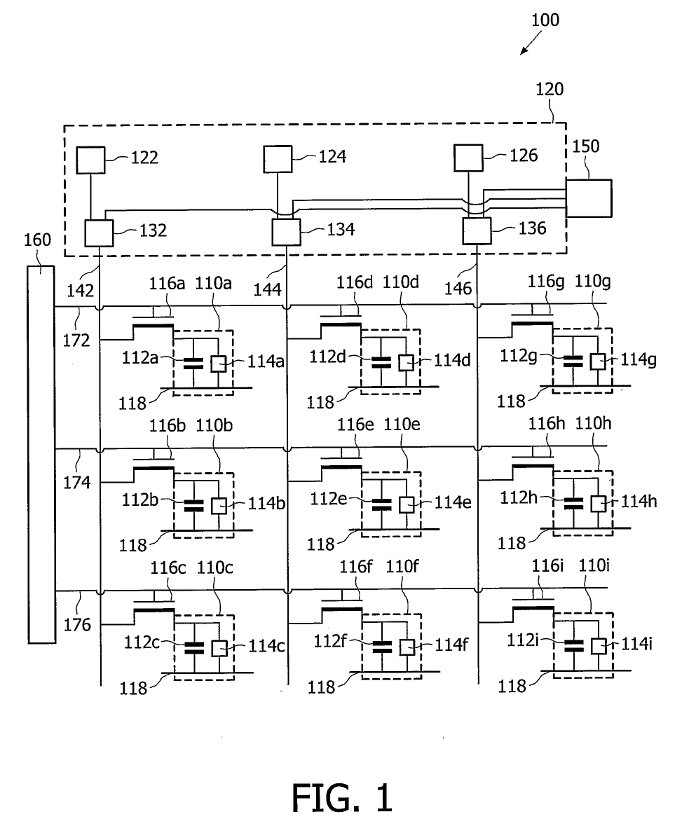

FIG. 1 schematically depicts a first proposed embodiment of an active matrix array device;

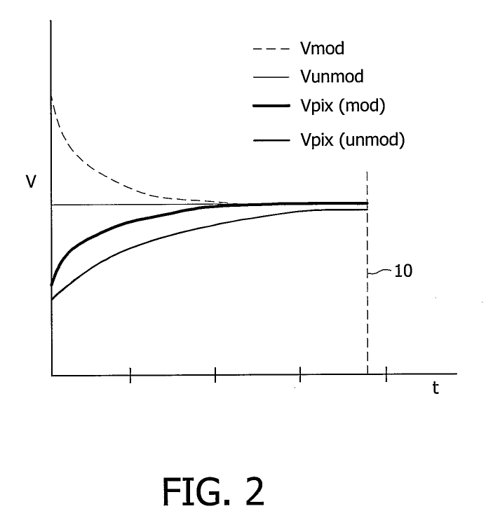

FIG. 2 schematically depicts a graph indicating the effect of applying a voltage waveform to an active matrix array element on the charge time of the charge storage element of the active matrix array element;

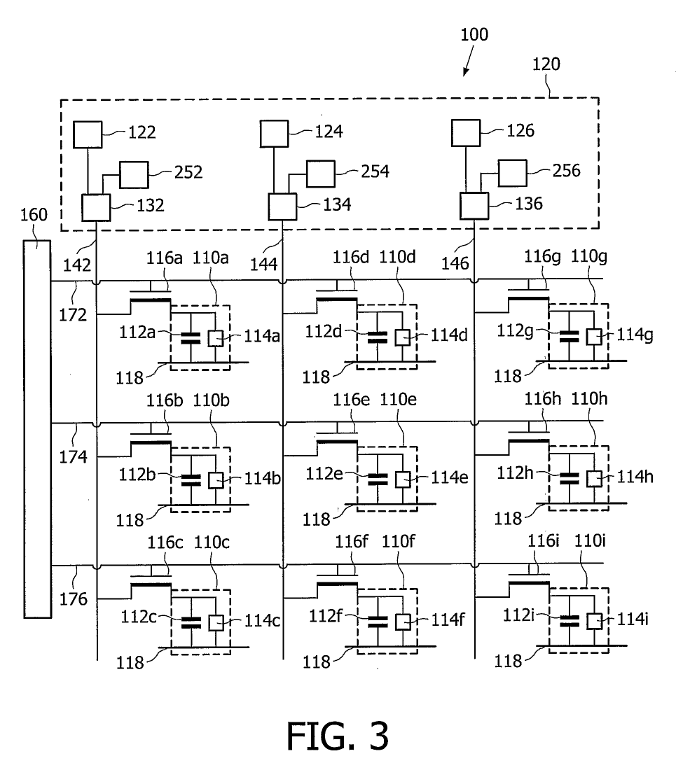

FIG. 3 schematically depicts another proposed embodiment of an active matrix array device;

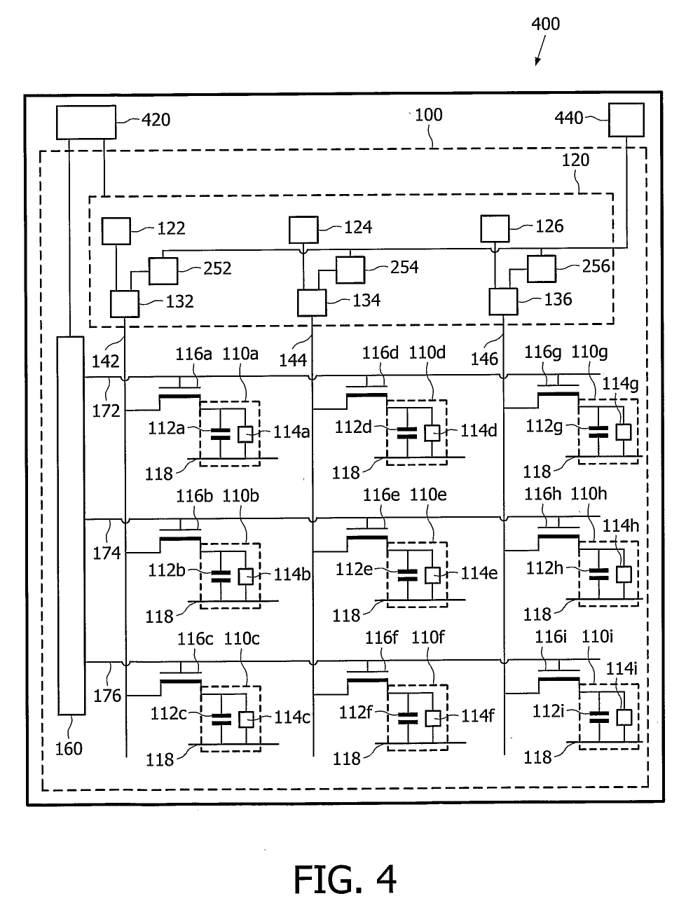

FIG. 4 schematically depicts the proposed active matrix device implemented as a display device;

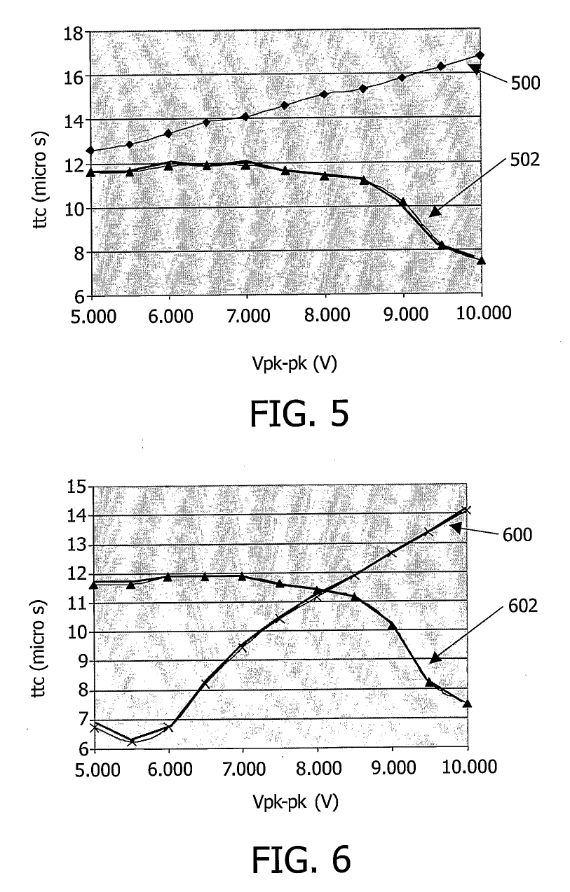

FIG. 5 shows the time to charge (ttc) pixels using a drive scheme and apparatus of the invention;

FIG. 6 shows the time to charge (ttc) pixels using a drive scheme and apparatus of the invention and shows the effect of varying the step duration;

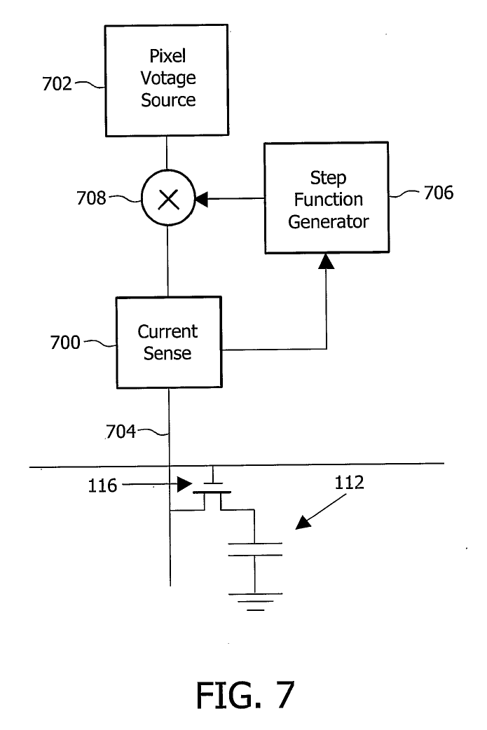

FIG. 7 shows a first example of apparatus of the invention; and

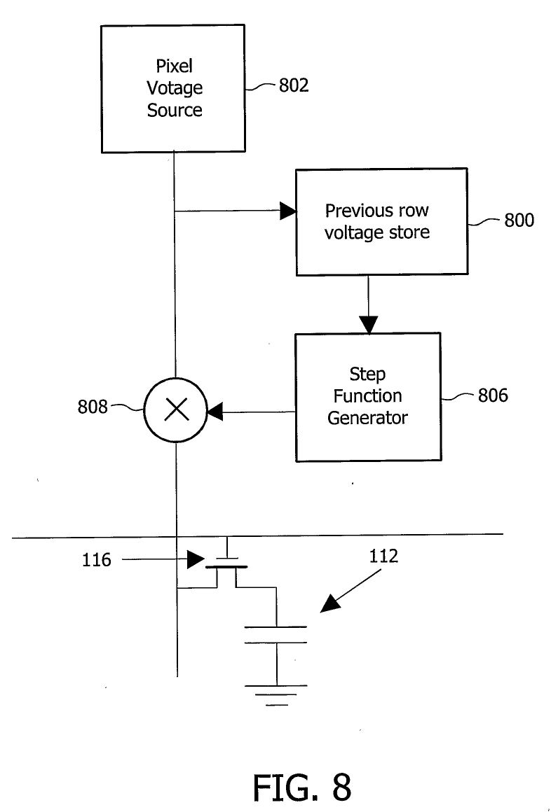

FIG. 8 shows a second example of apparatus of the invention.

It should be understood that the Figures are merely schematic and are not drawn to scale. In particular, certain dimensions such as the thickness of layers or regions may have been exaggerated whilst other dimensions may have been reduced. It should also be understood that the same reference numerals are used throughout the Figures to indicate the same or similar parts.

The applicant has proposed (but not yet published) an active matrix array device and method for modifying the drive voltage waveforms applied to the active matrix array pixels, in order to reduce the charge time of the array pixels.

The system that has been proposed will first be described with reference to FIGS. 1 to 4. This invention provides a modification to the system described with reference to FIGS. 1 to 4, and is described with reference to FIGS. 5 to 8.

The active matrix array device 100 in FIG. 1 has a plurality of active matrix array elements 110a-i, which include respective charge storage elements 112a-i and output elements 114a-i, which may be capable of storing a charge as well. The charge storage elements 112a-i are each arranged to maintain a state of one of the output elements 114a-i over a predefined period of time. In the case of the active matrix array device 100 being a display device, the output elements 114a-i may for instance be LC or poly-LED cells. In FIG. 1, the charge storage elements 112a-i are coupled between respective thin film transistors (TFTs) 116a-i and a common electrode 118. It should, however, be appreciated that this is by way of non-limiting example only; other arrangements where the common electrode 118 has been replaced by other electrode arrangements known in the art, such as arrangements where dedicated conductors or neighbouring addressing conductors function as electrode, are equally feasible. Each of the TFTs 116a-i have a source coupled to one of the charging conductors 142, 144 and 146 that form the column conductors of active matrix array device 100 and a gate coupled to one of the addressing conductors 172, 174 and 176 that form the row conductors of active matrix array device 100. Each of the charging conductors 142, 144 and 146 is coupled to a respective stage 122, 124 and 126 of the driver circuit 120 via a respective voltage modification circuit 132, 134 and 136.

The driver circuit 120 may be any row or column driver circuit known to a person skilled in the art, and may be arranged to process an analogue or a digital input signal. Each of the addressing conductors 172, 174 and 176 is coupled to a further driver circuit 160, which may be any row or column driver circuit known to a person skilled in the art. In addition, the active matrix array device 100 may be a display device, but the present invention can be applied to other active matrix array application domains as well, like sensor or memory devices. Furthermore, it is emphasized that the number of elements like the matrix array elements and the conductors shown in FIG. 1 and the following Figs. is chosen for reasons of clarity only; it will be appreciated by those skilled in the art that the active matrix array devices of the present invention typically include a substantially larger number of such elements than shown in the Figs.

The voltage modification circuits 132, 134 and 136 each have a first input coupled to an output of a respective stage 122, 124 and 126 and a second input coupled to a voltage waveform generator 150. The voltage waveform generator 150 may include a memory device (not shown) coupled to a digital-to-analogue converter (not shown) for generating a predefined analogue waveform that is stored in a digitized form in the memory device, or may be arranged to generate the voltage waveform in another known way. The memory device may be a programmable device like a random access memory or a look-up table, which may be part of a field programmable gate array (FPGA) device implementing the voltage waveform generator. The use of a programmable memory device enables the programming of a voltage waveform into the memory after the active matrix array device has been fabricated, which enables compensating for the effects of process variations and/or ageing effects of the active matrix array device, which will be explained in more detail below.

The arrangement of the voltage waveform generator 150 and the voltage modification circuits 132, 134 and 136 can be used to compensate for the problems that originate from the limited electron mobility characteristics of TFTs 116a-i. Typically, the voltage modification circuits 132, 134 and 136 will provide respective charging conductors 142, 144 and 146 with an overdrive voltage, that is, a higher voltage than the intended voltage to be stored in the respective associated charge storage devices of the matrix array elements 110a-i that are switched on by one of the addressing conductors 172, 174 and 176 so as to reduce the time it takes to charge the associated charge storage devices, that is, the charge storage devices 112a-i and/or the output elements 114a-i, during a charge cycle of the corresponding active matrix array elements 110a-i.

This principle is demonstrated in FIG. 2. V_{unmod} is the output voltage of one of the stages 122, 124 and 126 and is defined as the potential difference between the stage of the driver circuit 120 and the common electrode 118 of the active matrix array device 100. Therefore, V_{unmod} typically corresponds with the intended potential difference across the addressed charge storage element, that is, one of the charge storage elements 112a-i and/or one of the output elements 114a-i, which may be capacitors or equivalent devices. V_{pix(unmod)} demonstrates the actual potential difference over the addressed charge storage element after time period t. Typically, V_{pix(unmod)} lags behind the voltage V_{unmod} applied to the appropriate charging conductor, because of the limited electron mobility of the TFT that couples the charging conductor to the charge storage element. Also, as the potential over the charge storage element approaches the intended voltage V_{unmod}, the source-drain voltage of the associated TFT approaches 0V, which also adds to the charge time of the charge storage element. This may lead to situations where at the end of a charge cycle, as indicated by dotted line 10, when the associated TFT is switched off, V_{pix(unmod)} across the charge storage element differs to such an extent from V_{unmod} that deviations from the intended performance of the associated output element, that is, one of the output elements 114a-i, occur. In the case of the output element performing a display function, this typically means that a difference in the brightness level of the output element from the intended brightness level can be observed, which is a highly unwanted situation.

This can be avoided by providing a charging conductor with a voltage V_{mod}, which is generated by one of the voltage modification circuits 132, 134 and 136 by combining a voltage waveform having a similar shape as V_{mod} with the output voltage V_{unmod} of the corresponding stage of the driver circuit 120. The voltage waveform may be generated internally in each of the voltage modification circuits 132, 134 and 136, for instance by including the functionality of voltage waveform generator 150 in each of the voltage modification circuits 132, 134 and 136, or may be obtained from one or more external voltage waveform generators like voltage waveform generator 150. The application of V_{mod} to the charging conductor has the effect that the addressed charge storage device is initially overdriven by the driver circuit 120, which causes the charge storage device to become charged more rapidly, as can be seen from the corresponding charging profile V_{pix(mod)}, thus more effectively utilizing the high mobility region of the associated TFT.

The required voltage waveform used to modify V_{unmod} can be obtained by modelling the response time of the charge storage element as depicted in V_{pix(unmod)} to a charging voltage V_{unmod}.

An example of how such a required voltage waveform can be obtained is given below. The response of a voltage v across the matrix array element 110a-i to a constant voltage v₀ on the associated charging conductor 142, 144 or 146 as a function of time can be approximated by

$$\frac{ⅆ v}{ⅆ t} + \frac{v}{rc} = \frac{{v}_{0}}{rc} \qquad ( 1 )$$

where rc is the effective time constant of the charge storage device 112a-i and/or the capacitive output element 114a-i of the matrix array element 110a-i. Equation (1) has solution

$$v = {v}_{0} ( 1 - a {ⅇ}^{- \frac{t}{rc}} ) \qquad ( 2 )$$

To obtain a shorter charge time for the charge storage device, equation (2) can be modified to

$$v = {v}_{0} ( 1 - a {ⅇ}^{- \frac{t}{m}} ) \qquad ( 3 )$$

where m<rc. To achieve this it is noted that equation (1) can be rewritten to

$$\frac{ⅆ v}{ⅆ t} + \frac{v}{rc} = \frac{f ( t )}{rc} \qquad ( 4 )$$

where f(t) is the overdriven column voltage as a function of time. To obtain the desired voltage waveform, equation (3) is substituted into equation (4) to obtain

$$f ( t ) = {v}_{0} \{ 1 + a {ⅇ}^{- \frac{t}{m}} ( \frac{rc}{m} - 1 ) \} \qquad ( 5 )$$

defining the desired voltage waveform.

Alternatively, in the case of the voltage modification circuit 132, 134 and/or or the voltage waveform generator 150 being programmable, such a voltage waveform can be based on performance measurements after production of the active matrix array device. It will be obvious to those skilled in the art that the amount of overdriving can be varied to match the charge time of the charge storage elements 112a-i and/or output elements 114a-i to a predetermined charge period.

Now, on turning back to FIG. 1, it is pointed out that the output voltage of a stage 122, 124 or 126 of the driver circuit 120 can be combined with a voltage waveform in several ways. One possible way is by multiplying the output voltage of the stage with the voltage waveform. This has the advantage that for all non-zero output voltages the relative amount of overdriving is a fixed factor, while at an output of 0V of one of the stages 122, 124 or 126 the output of the associated voltage modification circuit 132, 134 or 136 remains 0V as well. Such a voltage modification circuit can be implemented by means of an analogue multiplier or by means of pulse width modulation techniques. A simple implementation would be a mere transistor, with the output of one of the stages 122, 124 and 126 coupled to its gate and the voltage waveform generator 150 coupled to the source of the transistor. Alternatively, the voltage modification circuits 132, 134 or 136 may be micro controllers having their respective outputs coupled to respective charging conductors 142, 144 and 146 via a digital-to-analogue converter, in which case the inputs of the voltage modification circuits 132, 134 or 136 may be fed with digital rather than analogue signals, which would obviate the need of a digital to analogue conversion step in the case the stages 122, 124 and 126 of the driver circuit 120 using digital input data. In addition, it would also obviate the need for digital to analogue conversion step in the voltage waveform generator 150.

Preferably, the voltage waveform generator 150 is capable of generating different voltage waveforms. This is for instance advantageous when the active matrix array device 100 has LC output elements 114a-i, which typically are addressed in alternating cycles of reversing polarity to prevent or delay the degradation of the LC material. Typically, the conductivity characteristics of the associated TFTs 116a-i in the positive cycle differ from their conductivity characteristics in the negative cycle. By application of different voltage waveforms in the two cycles, the different delays in the charge times of the associated charge storage elements 112a-i that arise from these different conductivity characteristics can both be effectively compensated. In extreme situations, it may be necessary to slow down the charge time of a charge storage element 112a-i in one of these two cycles to get a good match between the charge times in the respective cycles. The voltage waveform generator 150 may be made responsive to the field or frame period of the active matrix array device 100, that is the time between two successive addresses of one and the same addressing conductor 172, 174 or 176.

The conductivity characteristics of the TFTs 116a-i are not the only factors that influence the RC time constants of the charge storage elements 112a-i. An increasing length of the conductive path between one of the charge storage elements 112a-i and the corresponding stage 122, 124 or 126 of the driver circuit 120 increases the RC time constant of that charge storage element. In other words, the charge storage elements 112a, 112d and 112g that are coupled to addressing conductor 172 have a shorter RC time than for instance the charge storage elements 112c, 112f and 112i that are coupled to addressing conductor 176, because the latter three charge storage elements experience a larger impedance in the path between respective stages 122, 124 and 126 and respective TFTs 116c, 116f and 116i due to the increased length of the current path through the charging conductors 142, 144 and 146.

To compensate for this effect, the voltage waveform generator 150 can be configured to select a suitable voltage waveform from a plurality of voltage waveforms, each of these voltage waveforms being designed to compensate for a particular length of the current path between one of the stages 122, 124 and 126 and one of the charge storage devices 112a-i. The plurality of waveforms may contain different sets of voltage waveforms for the different polarities of the charging cycles. The voltage waveform generator 150 may be made responsive to addressing conductor selection means like the aforementioned dedicated hardware used to generate the timing signals from a video signal to control the timing of the further driver circuit 160 or the driver circuit 120 in the case of the active matrix array device 100 being a display device, and a new voltage waveform may be selected upon selection of a new addressing conductor, or may be selected after a number of addressing conductors have been addressed, effectively grouping subsets of the addressing conductors 172, 174 and 176 of active matrix array device 100 into different groups.

The length of the current path between the further driver circuit 160 and a gate of one of the TFTs 116a-i can also have a marked effect on the gate delay of the TFTs 116a-i coupled to the corresponding charge storage elements 112a-i. For instance, TFT 116g coupled to charge storage element 112g on charging conductor 146 may experience a larger gate delay than TFT 116a coupled to charge storage element 112a on charging conductor 142, because the effective length of the addressing conductor 172 between the further driver circuit 160 and the gate of TFT 116g is longer than the effective length of the addressing conductor 172 between the further driver circuit 160 and the gate of TFT 116a. Consequently, the gate of TFT 116g experiences a higher impedance on the addressing conductor 172 than the gate of TFT 116a does, which means that TFT 116g is turned on more slowly than TFT 116a. Thus, the effective charge period of charge storage element 112g is shorter than that of charge storage element 116a.

Another detrimental effect that can lead to a similar effect on these charging times is the deterioration of the address pulse provided by the further driver circuit 160 to switch on the TFTs. Upon progression of the address pulse along an addressing conductor 172, 174 or 176, the pulse shape can deform, which may lead to the TFTs that are further away from the further driver circuit 160 being less effectively switched on than those nearer to the further driver circuit 160.

This can be compensated for by supplying a subset of the voltage modification circuits 132, 134 and 136 with separate voltage waveform generators 252, 254 and 256, as shown in FIG. 3. The subset of the voltage modification circuits may contain as little as a single voltage modification circuit, in which case each of the modification circuits has its own voltage waveform generator, or may contain a small number of voltage modification circuits, in which case the charging conductors of the active matrix array device 100 are divided into sections that each have their own separate voltage waveform generator. The charging conductors 142, 144 and 146 can be separated into groups based upon the gate delay characteristics of the associated TFTs 116a-i, with separate groups being supplied by separate voltage waveform generators 252, 254 and 256, each of the voltage waveform generators 252, 254 and 256 compensating for the section characteristic gate delay of the associated TFTs.

Preferably, the voltage waveform generators 252, 254 and 256 will contain different pluralities of waveforms to compensate for the different polarity cycles when applicable, the dependency of the RC time of the associated charge storage devices 112 a-i and/or output devices 114a-i on addressing conductor position and the dependency of the RC time of the associated charge storage devices 112 a-i and/or output devices 114a-i on charging conductor position. It is emphasized that the various embodiments of the voltage waveform generator 150 as shown in FIG. 1 and describe in its detailed description may also be applied to the separate voltage waveform generators 252, 254 and 256 without departing from the scope of the invention.

FIG. 4 shows a preferred embodiment of an electronic display device 400 having an active matrix array device 100 according to the present invention. The driver circuit 120 and the further driver circuit 160, which may be an integral part of active matrix array device 100 or may be separate components, are coupled to a power supply 420. The voltage waveform generators 252, 254 and 256 are coupled to a further power supply 440, which may be an integral part of power supply 420. For reasons discussed above, the electronic display device 400 is capable of providing an improved picture quality compared with conventional display devices in terms of brightness control. In addition, if the voltage waveform generators 252, 254 and 256 are programmable, the quality of the electronic display device 400 may be improved after its manufacture or during its lifecycle. Typically, electronic display devices suffer from slowly deteriorating picture quality because of ageing effects of the various components, like the degradation of TFTs 116a-i and/or the degradation of the chemical compounds used in output devices 114a-i, that are used as building blocks of the active matrix array device 100. The display quality can be improved by the following method.

In a first step, the electronic display device 400 is provided with a predefined test image, and in a second step, a manifestation of the test image on the active matrix array of the electronic display device 400 is measured. This manifestation may be an actual image on the display area of the electronic display device 400, or may be a collection of electrical signals on the conductors of the active matrix array device 100. In the case of the manifestation being an actual image, the measurement can be done with known optical sensors, which may be temporarily attached to the screen. This has the advantage that light pollution from the surroundings is minimized. For this reason, it may be preferable to perform the measurement in a dark room.

In a next step, the measured manifestation of the test image is compared with the predefined test image. In case of the manifestation of the test image being a collection of electrical signals, the value of these signals is compared with the intended values corresponding to the test image. If a difference between the manifestation of the test image with the predefined test image is observed the electronic display device 400 is provided with an updated voltage waveform for compensating the observed difference, which is stored in the programmable voltage waveform generator 150, or when present, in one of the separate programmable voltage waveform generators 252, 254 and 256. These steps may be repeated until all the voltage waveforms stored in the voltage waveform generator 150 or in the separate programmable voltage waveform generators 252, 254 and 256 have been updated.

The updated voltage waveform may be calculated based on the voltage waveform stored in the programmable voltage generator 150 or one of the programmable voltage waveform generators 252, 254 and 256. To this end, the method may comprise an additional step of retrieving the voltage waveform from the electronic display device 400.

The approach proposed above is based on a modification to the column voltage as expressed in equation (5) above.

The overdrive waveform given by equation (5) however has some practically undesirable features. Firstly, its initial value can be very large and secondly it is difficult to generate in its exact form. It would be desirable to limit the maximum voltage and to approximate the exponential by a series of steps and for the simplest form of implementation there would only be one step.

A further complication is that the theory developed above to illustrate the technique assumes that the pixel and column conductor are initially at zero volts before charging takes place. If the pixel and column are charged from an effective initial value of Vᵢ (depending on the previous frame pixel voltage and previous row column voltage) equation (5) becomes:—

$$f ( t ) = {V}_{0} \{ 1 + ( 1 - \frac{{V}_{i}}{{V}_{0}} ) a {ⅇ}^{- \frac{t}{m}} ( \frac{rc}{m} - 1 ) \} \qquad ( 6 )$$

and so the multiplication factor, applied to V₀ depends also on the initial voltage state of the row and column.

The initial voltage Vᵢ in this equation is the effective starting voltage from which charging takes place. Two factors influence this voltage, as explained above, and these are the previous pixel voltage and the previous column (charging conductor) voltage. As the array is addressed row by row, the previous column voltage is not the same as the previous voltage applied to the pixel, which was instead a full frame period earlier.

The modelling of constant proportional overdrive voltage step functions has shown that a useful acceleration can be gained by ignoring the dependence on Vᵢ.

FIG. 5 shows the time to charge (ttc) a pixel to within 0.01 volts of its desired value when switching from the −ve to the +ve charge phase as a function of the column peak to peak voltage (grey scale).

Plot 510 shows the un-accelerated case whilst plot 502 overdrives the column by 20% on the peak to peak voltage for 6.3 μs, then steps down to the required final voltage for the remainder of the row address period (of approximately 20 μs). Thus, FIG. 5 shows an improvement in charging time even when a constant additional voltage step is applied which takes no account of the initial conditions of the matrix element. The overdrive voltage, does however take into account the drive level to be applied to the pixel, and the voltage step height is proportional to this voltage drive level, but is independent of the previous (opposite polarity) drive level. The step function can thus be implemented as a multiplication (of 1.2 and of 1), although it could equally be implemented as an addition.

In particular, it can be seen that an improvement of 5 μs is obtained over the greyscale range compared to the worst case un-accelerated time of approximately 17 μs. However, if the initial pixel and column voltage could be allowed for, an additional benefit would be available as the position of the minima in the accelerated curve, in FIG. 5, is determined by the time for which the additional overdrive voltage is applied.

This effect is shown in FIG. 6. In this figure, the time to charge is plotted against the grey scale voltage for a −ve to +ve cycle transition again with the 20% proportional step function overdrive and two overdrive durations of 5.7 μs (plot 600) and 6.3 μs (plot 602). It can be seen that if the overdrive duration can be tailored to the required grey scale transition, then an additional advantage is to be gained by ensuring operation is in the minimum of the accelerated curve. In the example shown, a time to charge of approximately 9 μs may be achievable.

As mentioned above, there are two factors which contribute to the initial charging conditions. If the initial pixel voltage (namely the voltage applied during the previous frame period) is a significant contributor to the “effective” initial voltage Vᵢ, then a frame store can be used in order to determine the optimum overdrive duration. This is an expensive solution to the problem if the device does not already require a frame store.

As the charge rate at any given time during the overdrive transient will be related to the initial voltage conditions, it is possible to monitor the charging current at a specific (early) time, and a decision can then be made as to how much longer to continue with overcharging.

FIG. 7 shows a schematic diagram of a system for operating in this way.

A current sensing circuit 700 is provided between the voltage generator 702 and the charging conductor 704. The drive circuitry comprises a conventional voltage generator 702 and a step function generator 706, and the step function generator is controlled in real time in dependence on the measured current at the beginning of the address phase. The step function applied to the pixel voltage source output by unit 708 which can be implemented as an adder or a multiplier. The measured charging current depends on the initial voltage state of the matrix element being driven, so that the step voltage waveform is applied for a time that depends on the initial charging conditions.

A function or look up table can be used, either generated experimentally or by modelling or by analytic theory, that can relate the charge rate to the required overcharge duration necessary to obtain near optimum acceleration for any pixel in the display.

If, however the previous voltage on the column (resulting from the addressing of a preceding row) is the major contributor to Vᵢ then, whilst the current sense solution could still be used, a simpler and low cost alternative is to use a row store of previous column voltages in order to determine the overdrive step time.

A system for implementing this approach is shown in FIG. 8.

A memory 800 is provided for storing the most recent previous output voltages applied to the charging conductors, and this enables the step voltage waveform to be applied for a time that depends on the most recent previous output voltage applied to the charging conductor.

The data in the memory is used in the control of the step function generator 806, which again provides an output which is added to (or multiplied with) the output of a conventional voltage generator 802 by unit 808.

In the examples above, a system has been described which provides an over-voltage drive based on a single voltage step, with controlled duration (or duty cycle to be more exact) and height. It will be clear that references to the duration of the step voltage waveform relate to the duration of the high part of the step waveform. The invention may be implemented using a multiple step overdrive waveform, and this will be apparent to those skilled in the art.

No detailed circuit implementations have been given, as this will be routine to those skilled in the art, and conventional circuits can be used.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. An active matrix array device (100) comprising:
a plurality of matrix elements (110a-i), each matrix element comprising a charge storage device (112a-i);
a plurality of charging conductors (142, 144, 146; 704), each charging conductor being coupled to a subset of the plurality of matrix elements (110a-i) via respective thin film transistors (116a-i); and
a driver circuit (120; 702) for generating a plurality of output voltages and comprising a plurality of voltage modification circuits (706, 806), each driver circuit output being coupled to one of the charging conductors via one of the voltage modification circuits (706, 806), each voltage modification circuit being arranged to apply a step voltage waveform for modifying the output voltage to modify a charge time of one of the charge storage devices (112a-i) coupled to the charging conductor (142, 144, 146; 704).

2. An active matrix array device (100) as claimed in claim 1, wherein each voltage modification circuit (706, 806) applies a step waveform to an adder or multiplier (708, 808), which combines the step waveform with a driver circuit output voltage.

3. An active matrix array device as claimed in claim 1, wherein the step voltage waveform has a step height which is a constant proportion of the driver circuit output voltage.

4. An active matrix array device as claimed in claim 1, wherein the step voltage waveform is applied for a time that depends on the initial voltage state of the matrix element being driven.

5. An active matrix array device as claimed in claim 4, comprising a frame store for storing the voltage state applied to each matrix element during a preceding addressing phase.

6. An active matrix array device as claimed in claim 1, further comprising current sensing circuitry (700) for measuring a charging current during initial application of an output voltage to a charging conductor (704).

7. An active matrix array device as claimed in claim 6, wherein the measured charging current depends on the initial voltage of the matrix element driven, and the step voltage waveform is applied for a time that depends on the measured current.

8. An active matrix array device as claimed in claim 1, wherein the step voltage waveform is applied for a time that depends on the most recent previous output voltage applied to the charging conductor.

9. An active matrix array device as claimed in claim 1, further comprising a memory (800) for storing the most recent previous output voltages applied to the charging conductors.

10. An active matrix array device as claimed in claim 1, comprising a display device, wherein the matrix elements comprise display pixels.

11. An active matrix array device as claimed in claim 10, wherein the display pixels comprise liquid crystal display pixels.

12. An active matrix array device as claimed in claim 10, wherein the display pixels comprise organic light emitting diode display pixels.

13. A method of addressing an active matrix array device, the device comprising a plurality of matrix elements (110a-i), each matrix element comprising a charge storage device, and a plurality of charging conductors each coupled to a subset of the plurality of matrix elements (110a-i) via respective thin film transistors (116a-i), the method comprising:
providing a matrix element drive signal;
modifying the drive signal by adding a step voltage waveform to the matrix element drive signal for reducing the charging time for the charge storage device to be charged to the drive signal.

14. A method as claimed in claim 13, wherein the step voltage waveform has a step height which is a constant proportion of the drive signal.

15. A method as claimed in claim 13, further comprising applying the step voltage waveform for a time that depends on the initial voltage state of the matrix element being driven.

16. A method as claimed in claim 13, further comprising measuring a charging current during initial application of the modified voltage to a charging conductor.

17. A method as claimed in claim 16, further comprising applying the step voltage waveform for a time that depends on the measured charging current.

18. A method as claimed in claim 13, further comprising applying the step voltage waveform for a time that depends on the most recent previous drive voltage applied to the charging conductor.

19. A method as claimed in claim 18, further storing in a memory the most recent previous output voltages applied to the charging conductors.
